(19) United States
(12) Patent Application Publication
(10) Pub. No.: US 2015/0375411 A1
(43) Pub. Date: Dec. 31, 2015

(54) KNIFE WITH RETRACTABLE ARM

(71) Applicant: Becky Parr, Ann Arbor, MI (US)

(72) Inventor: Becky Parr, Ann Arbor, MI (US)

(21) Appl. No.: 14/317,338

(22) Filed: Jun. 27, 2014

(51) Int. Cl. B26B 29/06; B26D 3/24

(52) U.S. Cl. CPC B26B 29/063; B26D 3/24

(57) ABSTRACT

A cutting device for cutting a food into predetermined portions includes a blade member. The blade member has a cutting edge and a pair of opposing lateral edges. The cutting device further includes an alignment arm slidably received by the blade member, and adjustable between a retracted position and an extended position. The alignment arm assists in a cutting of equally sized portions of the food.

### FIELD

The present disclosure relates to a cutting device and, more specifically, to a cutting device with a retractable arm for use with a container for receiving ingredients to be cut into predetermined portions.

### BACKGROUND

Many types of foods are prepared and placed into a pan or container and then cut into predetermined portions. A chef or baker typically employs a pan to cook or provide a desired shape to the food being prepared. The prepared food is contained within the pan, and is typically cut into portions prior to serving or storing.

Usually, the prepared food contained within the pan is divided into a number of equally sized portions. Equal sized portions facilitate the aesthetic presentation of the food. Additionally, in commercial baking or restaurant operations, consistency in portion size is an essential aspect of meeting customer expectations, controlling the cost of the food sold, and determining the quantity of food that must be prepared.

One method of dividing the food into consistently sized portions is by using a ruler and a knife. The ruler is used to measure the desired portion sizes and mark the upper surface of the food. The ruler is then aligned with the marks and employed as a straight edge to guide the knife as the food is cut. Although this method can be effective, it is a time consuming, multi-step process. This method is also subject to measurement errors, and requires a steady hand to evenly cut along the straight edge of the ruler.

Known devices such as those illustrated in U.S. Pat. No. 892,552 to Rexer, U.S. Pat. No. 6,009,786 to Hjelden, and U.S. Pat. No. 6,745,660 to Caputo, have included a guide for a knife or a plurality of cutting blades, in order to cut food into equal sized portions. However, these devices typically require a skilled and steady hand to cut the equally sized portions, or are a multi-piece device that must be assembled and attached to an associated baking pan.

To overcome some of these disadvantages, a container and cutting blade as illustrated and disclosed in U.S. Pat. No. 8,146,469 to Parr, hereby incorporated by reference herein, is known. Indicia are formed on the container at selected intervals adjacent an outer peripheral edge. The cutting blade is adapted to extend from indicia on one side of the container to indicia on the other side of the container. The indicia provide a guide to readily align the cutting blade for cutting the food into selected sized portions.

It is sometimes necessary to cut food into equally sized portions when using a container having dimensions longer than the length of the blade, for example, when using a rectangular pan. Where the blade is sized to extend from indicia on opposing sides of a width of a rectangular pan, the blade is naturally unable to extend the length of the rectangular pan. In such cases, multiple cuts have had to be made with the blade, without the benefit of aligning the ends of the blade with indicia, which is undesirable.

There is a continuing need for a cutting device for efficiently cutting food within a container into predetermined sized portions. Desirable, the cutting device may be aligned with indicia formed on the container, to thereby facilitate the cutting of equally sized portions of food.

### SUMMARY

In concordance with the instant disclosure, a cutting device for efficiently cutting food within a container into predetermined sized portions, and which may be aligned with indicia formed on the container, to thereby facilitate the cutting of equally sized portions of food, has been surprisingly discovered.

In one embodiment, a cutting device for cutting a food into predetermined portions is disclosed. The cutting device includes a blade member having a cutting edge and a pair of opposing lateral edges. An alignment arm is slidably received by the blade member and configured to move between a retracted position and an extended position to assist in a cutting of equally sized portions of the food.

In another embodiment, a bakeware system for preparing food includes a container for receiving ingredients and for separating a resulting food into predetermined portions. The container has indicia formed on a surface thereof. Each of the indicium has a cooperating indicium. The bakeware system further includes a cutting device removably received by the container. The cutting device has a blade member with a cutting edge and a pair of opposing lateral edges. An alignment arm is slidably received by the blade member and configured to move between a retracted position and an extended position to assist in a cutting of equally sized portions of the food. The alignment arm in the extended position extends outwardly from the blade member for aligning the cutting device with at least one of the indicium.

In a further embodiment, a method for cutting food into predetermined portions is disclosed. The method includes the step of providing a container for receiving ingredients and for separating a resulting food into predetermined portions. The container has indicia formed on a surface thereof. Each of the indicium has a cooperating indicium on an opposing side of the container. The method additionally includes the step of providing a cutting device having a blade member with a cutting edge and a pair of opposing lateral edges. An alignment arm is slidably received by the blade member and configured to move between a retracted position and an extended position to assist in a cutting of equally sized portions of the food. The method further includes the steps of aligning a first one of the lateral edges with a selected one of the indicium, moving the alignment arm to the extended position, aligning the alignment arm in the extended position with the cooperating indicium of the selected one of the indicium, and forcing the cutting edge downwardly through the food while maintaining the first one of the lateral edges in alignment with the selected one of the indicium and the alignment arm in alignment with the cooperating indicium of the selected one of the indicium to form a first cut through the food.

### BRIEF DESCRIPTION OF THE DRAWINGS

The above, as well as other objects and advantages of the disclosure, will become readily apparent to those skilled in the art from the following detailed description of an embodiment of the invention when considered in the light of the accompanying figures, in which:

FIG. 1 is front elevational view of a cutting device according to an embodiment of the disclosure, with an alignment arm shown in a retracted position;

FIG. 2 is a front elevational view of the cutting device depicted in FIG. 1, with the alignment arm shown in an extended position;

FIG. 3 is a left side elevational view of the cutting device of FIG. 1;

FIG. 4 is a cross-sectional view of the cutting device, taken along section line 4-4 in FIG. 1;

FIG. 5 is a cross-sectional view of the cutting device, taken along section line 5-5 in FIG. 1;

FIG. 6 is a perspective view showing a cutting device removably received within a container containing a food and cooperating with the container to form a lengthwise first cut according to an embodiment of the disclosure;

FIG. 7 is a perspective view showing a cutting device removably received within a container containing a food and cooperating with the container to form a lengthwise second cut according to an embodiment of the disclosure; and

FIG. 8 is a perspective view showing a cutting device removably received within a container containing a food and cooperating with the container to form a widthwise cut according to an embodiment of the disclosure.

### DETAILED DESCRIPTION

The following description is merely exemplary in nature and is not intended to limit the present disclosure, application, methods, or uses. It should also be understood that throughout the drawings, corresponding reference numerals indicate like or corresponding parts and features. In respect of the methods disclosed, the steps presented are exemplary in nature, and the order of the steps is not regarded as necessary or critical unless otherwise disclosed.

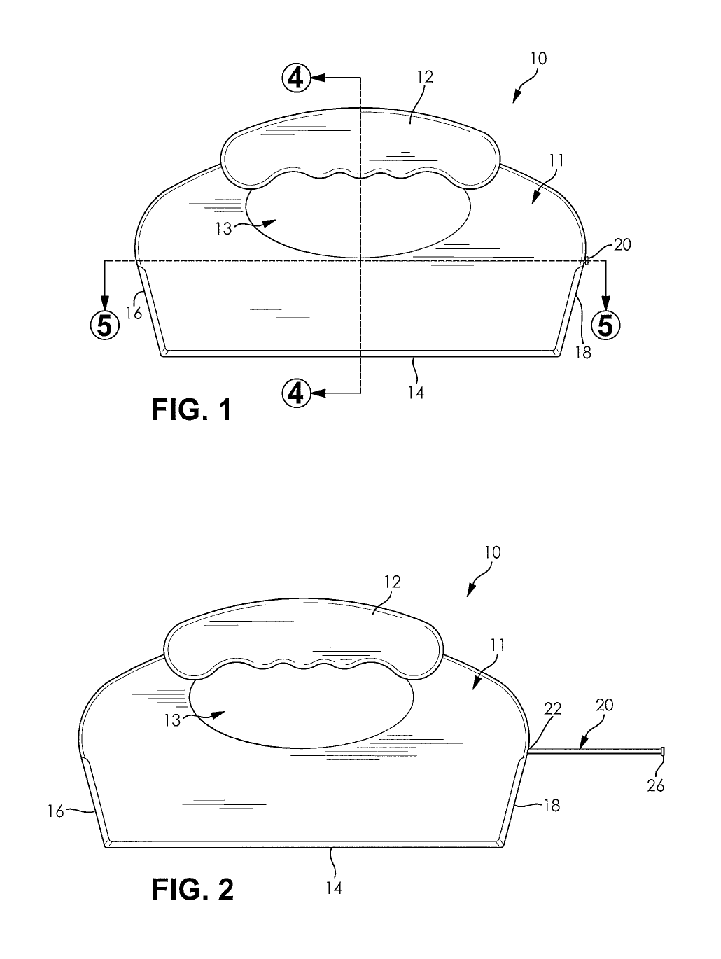

Referring to FIGS. 1-2, there is illustrated a cutting device 10 adapted to cooperate with a container to facilitate cutting of food contained therein into predetermined portions. The cutting device 10 can be adapted to cooperate with any container configured to hold food such as a plate, tray, pan, dish, etc. The cutting device 10 is provided with a blade member 11. The blade member 11 includes a cutting edge 14 at one end thereof, a first lateral edge 16 and a second lateral edge 18. The first lateral edge 16 is spaced apart from the second lateral edge 18. A handle 12 is disposed at an opposing end of the blade member 11 from the cutting edge 14. In certain embodiments, at least a portion of the lateral edges 16, 18 can also be configured as cutting edges, for example, as illustrated in FIG. 1.

In the embodiment shown in FIGS. 1-2, an aperture 13 is formed in the blade member 11 adjacent the handle 12. The aperture 13 facilitates a gripping of the cutting device 10, in operation. Additionally, the lateral edges 16, 18 are configured to confirm in shape to a shape of an interior of the container with which the cutting device 10 is used. For example, the lateral edges 16, 18 may taper inwardly towards each other toward the cutting edge 14 and cooperate with the cutting edge 14. Other suitable shapes for the lateral edges 16, 18 may also be employed within the scope of the present disclosure.

The handle 12 can also have any suitable shape allowing the cutting device 10 to be gripped, as desired. For example, the handle 12 may be integrally formed with the blade member 11, or separately formed from the blade member 11 and attached thereto. The handle 12 can also have generally finger-shaped recesses on a bottom thereof, adjacent the aperture 13, which facilitate the gripping of the handle 12.

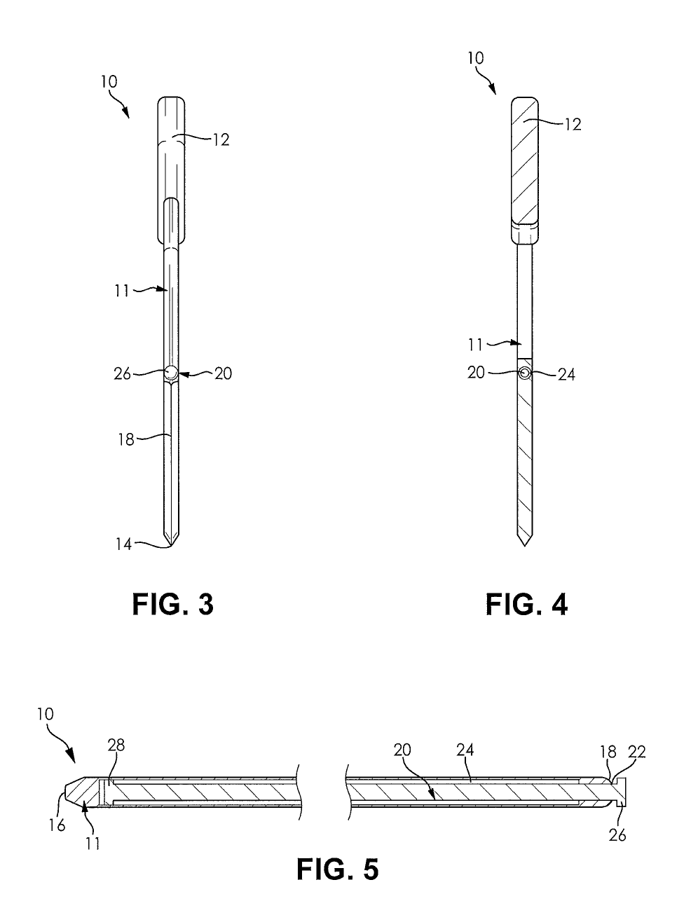

Referring to FIGS. 1-5, the cutting device 10 of the present disclosure further includes an alignment arm 20. The alignment arm 20 is adjustably and slidably received by the blade member 11. The alignment arm 29 is configured to move between a retracted position, as illustrated in FIG. 1, and an extended position, as illustrated in FIG. 2.

In certain embodiments, the alignment arm 20 is received through an opening 22 formed in the second lateral edge 18 of the blade member 11. As shown in FIG. 5, the opening 22 is continuous with an elongate cavity 24 formed in the blade member 11. The cavity 24 extends towards the opposing lateral edge 16 of the blade member 11. The cavity 24 is oriented substantially parallel to the cutting edge 14, and has a length configured to receive and store an entirety of the alignment arm 20.

In certain embodiments, the alignment arm 20 can include adjustment features that facilitate a manual movement the alignment arm 20 between the retracted and extended positions. For example, the alignment arm 20 can include a first flange 26 disposed at one end of the alignment arm 20, and a second flange 28 disposed at an opposing end of the alignment arm 20. The first flange 26 is disposed exterior to the blade member 11, and the second flange 28 is received in the cavity 24 formed in the blade member 11. Each of the flanges 26, 28 may have a cross-sectional area that is greater than a cross-sectional area of the opening 22. The first flange 26 provides a finger hold, which facilitates a movement of the alignment arm 20 from the retracted position to the extended position. The second flange 28 militates against the alignment arm 20 decoupling from the blade member 11, when the alignment arm 20 is adjusted to the extended position.

In other various embodiments, not shown, the alignment arm 20 can include other adjustment features, as desired. For example, the alignment arm 20 can be slidably coupled to a rail disposed in the cavity 24. Alternatively, the rail may be disposed exterior to the blade member 11. In one example, the alignment arm 20 can include a spring loaded mechanism coupled thereto, which allows the alignment arm 20 to retract within, and extend from, the blade member 11.

In other examples, a tab or other gripping device can extend from the alignment arm 20 and through a slot formed in the blade member 11 and continuous with the cavity 24. In such cases, the tab facilitates the movement of the alignment arm 20 from the retracted position to the extended position, and vice-versa.

Furthermore, in other examples, the alignment arm 20 can include a threaded portion engaging with a threaded portion defining the opening 22 or the cavity 24. It should be appreciated that the threaded engagement of the alignment arm 20 with the opening 22 or the cavity 24 facilitates both the movement of the alignment arm 20 and militates against the decoupling of the alignment arm 20 from the blade member 11.

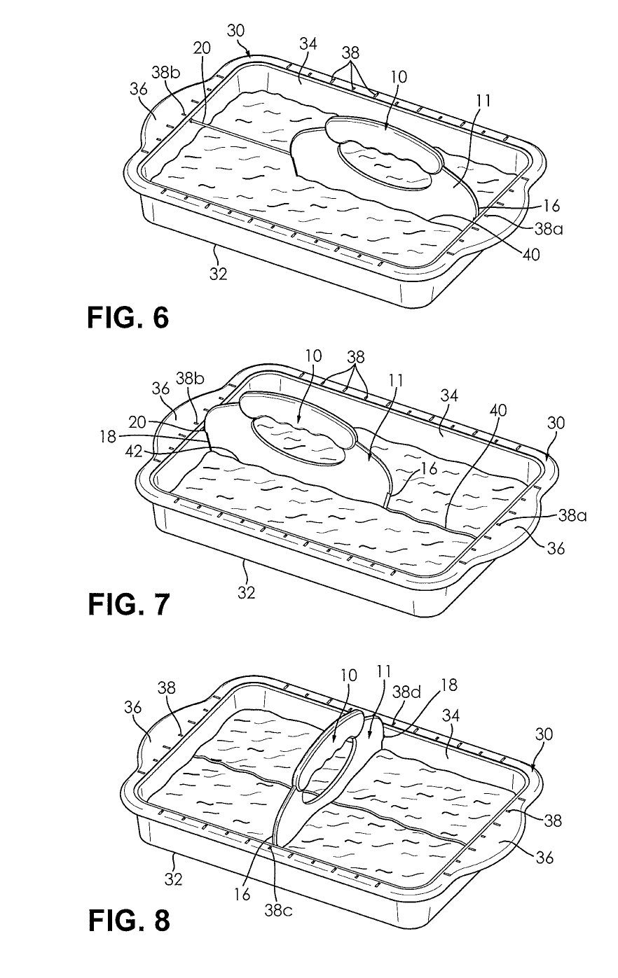

Referring now to FIGS. 6-8, the cutting device 10 engages with a container or a pan, generally indicated by reference numeral 30, for use in preparing food. The container 30 has a bottom 32 and a peripheral sidewall 34. The sidewall 34 is integral with the bottom 32 and extends upwardly therefrom terminating at an upper rim 36. A plurality of indicia 38 are formed in, or marked on, the upper rim 36. The indicia 38 are formed at selected intervals, and each indicium has a cooperating indicium. The indicia 38 can be color coded, numerically labeled, or otherwise marked to facilitate identifying the cooperating indicia.

In the illustrated embodiment, the bottom 32 of the container 30 is rectangular. It should be understood that the container 30 can be formed in other shapes such as square or circular, for example. Additionally, it should be understood that, rather than a pan, the container 30 can be a plate or tray having the indicia 38 formed adjacent a peripheral edge thereof. In a further embodiment, the indicia 38 can be formed in the sidewall 34 and bottom 32, and extend from the upper rim 36 at a one side of the container 30 to the upper rim 36 of the opposing side of the container 30, as desired.

In certain embodiments, such as illustrated in FIG. 8, the length of the cutting edge 14 of the cutting device 10 can be substantially equivalent to the distance between at least one set of the opposing sides of the sidewall 34 of the container 30. The cutting edge 14 is adapted to be removably received between opposing sides of the sidewall 34. Indicia can also be formed on the cutting device 10 adjacent the cutting edge 14 and/or at least one of the lateral edges 16, 18 of the blade member 11, in order to facilitate measuring distances and alignment of the cutting device 10 with the indicia 38 formed in the container 30.

The cutting device 10 can be formed from any suitable material, as desired. For example, the cutting device 10 can be formed from any durable material selected to provide a cutting edge, such as plastic and metal or combination thereof. Likewise, the cutting device 10 can be formed from any suitable process, such as a molding or machining process, as non-limiting examples. It should be understood that other materials and combinations of materials can be employed to form the cutting device 10, such as wood and glass for the handle 12 and plastic and metal for the blade member 11, as desired.

The container 30 can likewise be formed from any suitable material. In certain examples, the container 30 is formed from sheet metal by a stamping or bending processes. It should be understood that other materials may be employed to form the container 30 such as glass or a plastic having selected thermal properties, for example. Additionally, it should be understood that the interior surface of the container 30 and the outer surfaces of the cutting device 10 can be provided with a non-stick coating such as Teflon®, for example.

In operation, a user such as a chef or baker prepares a food such as cake, for example, by mixing the necessary ingredients, placing the mixed ingredients in the container 30, and then baking the ingredients in an oven. Typically, when the ingredients have been baked, the container 30 containing the food is removed from the oven and allowed to cool. The food is then cut into selected sized portions for serving or storage. The cutting device 10 is used to efficiently and accurately cut the selected sized portions.

The cutting device 10 can also be employed for other prepared food items such as no-bake items such as frozen desserts or gelatin based foods, bread, pie, brownies, prepared meat dishes such as meatloaf, layered food dishes such as lasagna or casseroles, pizza, or any other food, as desired.

With renewed reference to FIGS. 6-7, the cutting device 10 is particularly used with a container 30 having a length greater than the length of the cutting device 10.

To cut the food into the selected sized portions, the user holds the handle 12 of the cutting device 10 and aligns the first lateral edge 16 of the blade member 11 with a first indicium 38a of a selected pair of cooperating indicia 38a, 38b formed on the upper rim 36 of the container 30. The user then adjusts the alignment arm 20 to extend outwardly from the cutting device 10, to a distance where the alignment arm 20 aligns with a second indicium 38b of a selected pair of cooperating indicia 38a, 38b formed on the upper rim 36 of the container 30. The alignment arm 20 can be adjusted to extend from the retracted position to the extended position at a distance substantially equal to the length of the cutting device 10. The user then forces the blade member 11 of the cutting device 10 downwardly through the food while maintaining the first lateral edge 16 and the alignment arm 20 in alignment with the selected pair of cooperating indicia 38a, 38b to form a first cut 40 substantially perpendicular to the sidewall 34 of the container 30.

Once the first cut 40 is formed in the food, the user then relocates the cutting device 10 to form a second cut 42 along the length of the container 30. The user aligns the first lateral edge 16 of the blade member 11 with a portion of the previously formed first cut 40, as illustrated in FIG. 7. The alignment arm 20 and/or second lateral edge 18 is aligned with the second indicium 38b of the pair of cooperating indicia 38a, 38b formed on the upper rim 36 of the container 30. The user then forces the blade member 11 of the cutting device 10 downwardly through the cake to form the second cut 42.

Alternatively, prior to forming the second cut 42, the cutting device 10 can be rotated so that the first lateral edge 16 of the blade member 11 aligns with the second indicium 38b of the pair of cooperating indicia 38a, 38b. The alignment arm 20 can then be adjusted to extend outwardly from the cutting device 10 to a distance where the alignment arm 20 aligns with the first indicium 38a of a selected pair of cooperating indicia 38a, 38b formed on the upper rim 36 of the container 30. The user then forces the blade member 11 of the cutting device 10 downwardly through the cake to form the second cut 42.

It should be appreciated that the second cut 42 is made while maintaining the alignment arm 20 and/or the second lateral edge 18 with the second indicium 38b and first lateral edge 16 in alignment with the first cut 40 or while maintaining the first lateral edge 16 in alignment with the second indicium 38b and the alignment arm 20 in alignment with the first indicium 38a. The cutting process is then repeated at selected intervals indicated by the indicia 38, in order to cut the prepared food into selected sized portions without having to measure and mark the food prior to cutting.

As shown in FIG. 8, when the cutting device 10 has a cutting edge 14 equal to opposing sides of the sidewall 34, the user holds the handle 12 of the cutting device 10 and aligns the lateral edges 16, 18 thereof with a selected pair of cooperating indicia 38c, 38d formed on opposing sides of the upper rim 36 of the container 30. The user then forces the blade member 11 of the cutting device 10 downwardly through the cake, while maintaining the lateral edges 16, 18 thereof in alignment with the selected pair of cooperating indicia 38c, 38d. This forms a cut substantially perpendicular to the sidewall 34 of the container 30. The cutting process is repeated at selected intervals indicated by the indicia 38, in order to cut the prepared food into selected sized portions without having to measure and mark the food prior to cutting.

Advantageously, the cutting device 10 and the container 30 of the present disclosure cooperate with each other to facilitate cutting food into consistent portions of a selected size. A substantially linear and precise cut can be made across the length of the food, with an effortless repetitive downward motion of the cutting device 10. The alignment arm 20 of the cutting device 10 allows cuts to be formed more quickly and with greater precision in a container 30 having various dimensions, particularly in comparison to employing a knife to cut along a straight edge or using more than one cutting device 10 to accomplish the same task, as is known in the art.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A cutting device for cutting a food into predetermined portions, comprising:
a blade member having a cutting edge and a pair of opposing lateral edges; and
an alignment arm slidably received by the blade member and configured to move between a retracted position and an extended position to assist in a cutting of equally sized portions of the food.

2. The cutting device according to claim 1, wherein the alignment arm is slidable outwardly from at least one of the lateral edges to the extended position.

3. The cutting device according to claim 1, wherein the alignment arm is extendable from the blade member in a direction substantially parallel to the cutting edge.

4. The cutting device according to claim 1, wherein the blade member has an elongate cavity formed therein.

5. The cutting device according to claim 4, wherein the alignment arm is at least partially disposed in the cavity.

6. The cutting device according to claim 5, wherein the alignment arm includes a first flange disposed at one end thereof and disposed exterior to the blade member.

7. The cutting device according to claim 6, wherein the alignment arm includes a second flange disposed at an other end thereof, the second flange slidably retained in the cavity of the blade member and configured to militate against decoupling of the alignment arm from the blade member.

8. The cutting device according to claim 1, wherein the cutting edge and the pair of lateral edges together conform in shape to an interior surface of the container.

9. The cutting device according to claim 1, further comprising a handle disposed at an end of the blade member opposite the cutting edge.

10. The cutting device according to claim 1, wherein at least one of the lateral edges has a cutting edge.

11. A bakeware system for preparing food comprising:
a container for receiving ingredients and for separating a resulting food into predetermined portions, the container having indicia formed on a surface thereof, each of the indicium having a cooperating indicium; and
a cutting device removably received by the container, the cutting device having a blade member with a cutting edge and a pair of opposing lateral edges, and an alignment arm slidably received by the blade member and configured to move between a retracted position and an extended position to assist in a cutting of equally sized portions of the food, the alignment arm in the extended position extending outwardly from the blade member for aligning the cutting device with at least one of the indicium.

12. The bakeware according to claim 11, wherein the indicia are formed at selected intervals.

13. The bakeware according to claim 11, wherein the container includes a bottom and a sidewall extending outwardly therefrom and terminating at an upper rim.

14. The bakeware according to claim 11, wherein the cutting device cooperates with the container to separate the resulting food into predetermined portions.

15. The bakeware according to claim 11, wherein the blade member has an elongate cavity formed therein.

16. The bakeware according to claim 15, wherein the alignment arm is at least partially disposed in the cavity.

17. The bakeware according to claim 11, wherein the alignment arm includes a flange disposed at one end thereof configured to facilitate adjustment of the alignment arm.

18. A method for cutting food into predetermined portions, the method comprising the steps of:
providing a container for receiving ingredients and for separating a resulting food into predetermined portions, the container having indicia formed on a surface thereof, each of the indicium having a cooperating indicium on an opposing side of the container;
providing a cutting device having a blade member with a cutting edge and a pair of opposing lateral edges, and an alignment arm slidably received by the blade member and configured to move between a retracted position and an extended position to assist in a cutting of equally sized portions of the food;
aligning a first one of the lateral edges with a selected one of the indicium;
moving the alignment arm to the extended position;
aligning the alignment arm in the extended position with the cooperating indicium of the selected one of the indicium; and
forcing the cutting edge downwardly through the food while maintaining the first one of the lateral edges in alignment with the selected one of the indicium and the alignment arm in alignment with the cooperating indicium of the selected one of the indicium to form a first cut through the food.

19. The method according to claim 18, further comprising the steps of:
aligning the first one of the lateral edges with the first cut;
moving the alignment arm to the retracted position;
aligning one of the alignment arm and a second one of the lateral edges with the cooperating indicium of the selected one of the indicium; and
forcing the cutting edge downwardly through the food while maintaining the first one of the lateral edges in alignment with the first cut and the one of the alignment arm and the second one of the lateral edges in alignment with the cooperating indicium of the selected one of the indicium to form a second cut through the food.

20. The method according to claim 18, further comprising the steps of:
aligning the first one of the lateral edges with the cooperating indicium of the selected one of the indicium;
maintaining the alignment arm in the extended position;
aligning the alignment arm with the selected one of the indicium; and
forcing the cutting edge downwardly through the food while maintaining the first one of the lateral edges in alignment with the cooperating indicium of the selected one of the indicium and the alignment arm in alignment with the selected one of the indicium to form a second cut through the food.
